(19) United States
(12) Patent Application Publication
(10) Pub. No.: US 2025/0026313 A1
(43) Pub. Date: Jan. 23, 2025

(54) ADAPTER FOR A WIPING SYSTEM

(71) Applicant: VALEO SYSTÈMES D'ESSUYAGE, LE MESNIL SAINT DENIS (FR)

(72) Inventors: Vincent Gaucher, LE MESNIL SAINT DENIS (FR); Stéphane Houssat, LE MESNIL SAINT DENIS (FR); Eric Poton, LE MESNIL SAINT DENIS (FR); Olivier Jomard, LE MESNIL SAINT DENIS (FR)

(73) Assignee: VALEO SYSTÈMES D'ESSUYAGE, LE MESNIL SAINT DENIS (FR)

(21) Appl. No.: 18/685,503

(22) PCT Filed: Aug. 23, 2022
(86) PCT No.: PCT/EP2022/073514

§ 371 Date: Sep. 18, 2024

(30) Foreign Application Priority Data
Sep. 1, 2021 (FR) 2109133

(51) Int. Cl. B60S 1/40

(52) U.S. Cl. CPC B60S 1/40

(57) ABSTRACT

An adapter for fastening a wiper to an arm of a wiping system is disclosed. The adapter extends in a longitudinal direction. The adapter is configured to be rotatably mounted on a connector of the wiper about an axis of rotation transverse to the longitudinal direction by means of a rotation device. The adapter includes at least one lateral wall and a curved upper wall. The adapter is defined by a vertical and transverse section. The section is delimited by a first straight line parallel to the axis of rotation and passing through at least one point of the second end edge, a second straight line perpendicular to the first straight line and passing through at least one point of the first end edge, and the curved upper wall taken in the vertical and transverse section.

The field of the present invention is that of wiping systems for motor vehicles. More particularly, the field of the present invention is that of adapters positioned between a wiper arm and a wiper of such wiping systems.

Motor vehicles are commonly fitted with wiping systems for cleaning their glazed surfaces, and in particular their windshields. Such wiping systems comprise at least one wiper arm and a wiper driven by the wiper arm. The wiper arm is connected to an electric motor of the vehicle and the wiper comprises at least one wiper blade suitable for coming into contact with the glazed surface to be wiped. To enable the wiper to be driven, an adapter is arranged between this wiper and the wiper arm. More particularly, the adapter is arranged between the wiper arm and a connector attached to the wiper. The adapter is then rigidly connected to the wiper arm, and more particularly to a free end of the wiper arm, this cooperation being detachable so that the wiper can be changed when it is worn.

To provide optimal cleaning of the glazed surfaces of vehicles by means of the wiping systems, the wipers must be pressed against the glazed surface to be cleaned. Means contributing to the pressing of the wipers are thus known, such as deflectors positioned on the wipers and causing them to be pressed by the action of an air flow when the vehicle is in motion. However, although the pressing of the wipers is effective, it is not optimal, and can therefore be improved.

The aim of the invention is therefore to improve the pressing of the wipers against the glazed surfaces in a simple manner, in particular by generating a negative pressure area at the rear of the adapters, in a direction of circulation of the flow of air against the wiping system, thus improving the overall performance of the wiping system. In addition, this improvement takes into account other constraints such as the way in which the adapter is unlocked relative to the arm, the ergonomics of handling the adapter, and technical constraints resulting from esthetic requirements.

The invention provides a solution to all of these constraints by proposing an adapter for fastening a wiper to an arm of a wiping system, the adapter extending in a longitudinal direction, the adapter being configured to be rotatably mounted on a connector of the wiper about an axis of rotation transverse to the longitudinal direction by means of a rotation device, the adapter comprising at least one lateral wall and a curved upper wall comprising at least a first end edge and a second end edge that extend substantially in the longitudinal direction, the adapter being defined by a vertical and transverse section, the section being delimited by a first straight line parallel to the axis of rotation and passing through at least one point of the second end edge, by a second straight line perpendicular to the first straight line and passing through at least one point of the first end edge, and by the curved upper wall taken in the vertical and transverse section, the adapter being characterized in that the lateral wall extends from the upper wall and so that at least one point of a free end of the lateral wall is contained in the vertical and transverse section.

The wiper and the arm form part of a wiping system of a vehicle for at least partially cleaning a glazed surface of said vehicle. The wiping system thus comprises the arm rotated by an electric motor of the vehicle and rotating the wiper, to which it is rigidly connected via the adapter and the connector, against the glazed surface, so that the blade held by the wiper clears said glazed surface of raindrops and/or solid debris deposited thereon.

The upper wall and the lateral wall of the adapter contribute to the definition of an inner volume of the adapter in which the rotation device in particular extends. The lateral wall defines the vertical and transverse section, and this lateral wall is therefore wholly contained in this section.

In addition, the second end edge of the upper wall corresponds to the free end edge positioned across the air flow when the wiping system is positioned on the vehicle, the air flow streaming over the upper wall. In other words, the second end edge is the foremost end edge with respect to the vehicle when the wiping system is mounted on said vehicle. It will thus be understood that the first end edge and the lateral wall are positioned at the rear of the wiping system, between the glazed surface and the second end edge along a trajectory of movement of the air flow, when the wiping system is mounted on the vehicle.

The point of the second end edge is then defined as the point taken on the second end edge that extends vertically furthest away from the rotation device. Likewise, the point of the first end edge is defined as the point taken on the first end edge that extends transversely furthest away from the rotation device.

The point of the free end of the lateral wall is then contained inside a perimeter of the vertical and transverse section of the adapter. In other words, it will be understood that the point of the free end of the lateral wall does not extend vertically and transversely beyond the point of the second end edge and the point of the first end edge respectively. A negative pressure effect is thus created at the rear of the wiping system and more specifically at the rear of the adapter along the trajectory of the air flow, so as to increase the pressing of the wiper against the glazed surface of the vehicle. The performance of the wiping system is thus improved.

According to one feature of the invention, the lateral wall extends from the first end edge of the upper wall so as to extend in a longitudinal and vertical plane.

According to one feature of the invention, the point of the free end of the lateral wall is positioned in a longitudinal and vertical plane passing through the first end edge.

It will be understood that in such a configuration of the lateral wall, the point of its free end extends to the peripheral limit of the vertical and transverse section of the adapter defined above.

According to one feature of the invention, the lateral wall extends from the upper wall so that at least one point of a free end of the lateral wall does not extend beyond the axis of rotation R in the vertical direction.

According to one feature of the invention, the axis of rotation is contained inside a perimeter of the vertical and transverse section.

According to one alternative of the invention, the point of the free end of the lateral wall is positioned in the vertical and transverse section and a non-zero distance from a longitudinal and vertical plane passing through the first end edge.

The non-zero distance is taken along a straight line parallel to the axis of rotation of the adapter. It will thus be understood that in this alternative, the lateral wall extends in a plane intersecting the longitudinal and vertical plane passing through the first end edge of the upper wall.

According to one feature of the invention, the upper wall has a substantially constant thickness.

According to one feature of the invention, the lateral wall has a substantially constant thickness.

According to one feature of the invention, the curved upper wall comprises at least one air deflector that extends from the first end edge beyond the lateral wall in the transverse direction of the adapter.

The air deflector makes it possible to increase the pressing of the wiper against the glazed surface of the vehicle, thus optimizing the cleaning thereof. In addition, as the deflector extends from the first end edge of the upper wall, it will be understood that the air deflector contributes to increasing the negative pressure effect at the rear of the adapter along the trajectory of the air flow against the adapter.

According to one feature of the invention, the air deflector extends in the continuation of the curvature of the curved upper wall.

It will be understood that in such a configuration, the air deflector comprises an identical curvature to the upper wall when viewed from the rotation device.

According to one alternative of the invention, the air deflector protrudes from the first end edge of the upper wall, extending in the opposite direction to the lateral wall in the vertical direction.

It will be understood that the deflector extends vertically in the opposite direction to the inner volume of the adapter. The deflector then has a curved profile when viewed in a vertical and transverse plane. More particularly, the air deflector has a convex profile when viewed from the rotation device of the adapter.

According to one feature of the invention, the upper wall has a concave shape when viewed from the rotation device.

According to one feature of the invention, the adapter comprises at least one receiving recess configured to receive the arm of the wiping system, the receiving recess being delimited by at least four supporting walls perpendicular to each other, each of the supporting walls extending in a plane intersecting a longitudinal and vertical plane of the adapter.

It will be understood that the receiving recess has a substantially parallelepipedal shape so that it is inclined relative to a longitudinal and vertical plane of the adapter. It will also be understood that in such a configuration of the receiving recess, the arm is configured to be positioned inclined relative to the longitudinal and vertical plane of the adapter.

According to one feature of the invention, the receiving recess configured to receive the arm of the wiping system is positioned in an inner volume of the adapter defined by the upper wall and the lateral wall of the adapter.

According to one feature of the invention, the receiving recess comprises at least one locking member configured to longitudinally block the arm in the receiving recess.

More particularly, the locking means comprise at least one blocking member intended to longitudinally block the arm in the receiving recess.

According to one feature of the invention, the locking member contributes to the definition of the receiving recess, the locking member comprising handling means inscribed in the curvature of the upper wall.

More specifically, the handling means are connected to the blocking member by means of a connecting member, the blocking member contributing to the definition of the receiving recess. The handling means then form a portion of the locking member that is elastically deformable, i.e. that is capable of deforming and then returning to its initial non-deformed state without failure of the material thereof.

According to one feature of the invention, at least one point of the second end edge of the curved upper wall extends beyond the point of the free end of the lateral wall in the vertical direction.

According to one feature of the invention, at least one point of the second end edge of the curved upper wall extends beyond the point of the rotation device in the vertical direction.

The invention also relates to a wiper comprising at least one wiper blade, a connector and an adapter according to any one of the preceding features, the blade being held directly or indirectly by the connector, and the adapter being pivotably mounted relative to the connector.

The invention also relates to a wiping system for a motor vehicle, which comprises a wiper according to the preceding feature, connected to an arm of the wiping system by translation of the arm inside the adapter.

Further features, details and advantages of the invention will become more clearly apparent from reading the description given below by way of illustration with reference to the drawings, in which:

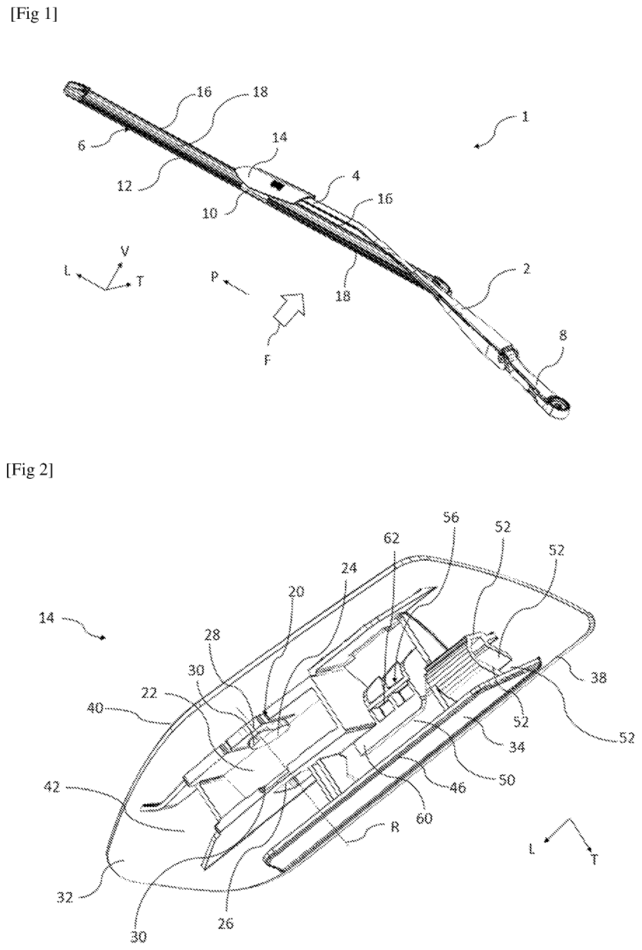

FIG. 1 is a general perspective view of a wiping system according to the invention, comprising at least one adapter positioned between a wiper arm and a wiper;

FIG. 2 is a view of the adapter in FIG. 1 showing an inner volume in which a rotation device of the adapter is positioned;

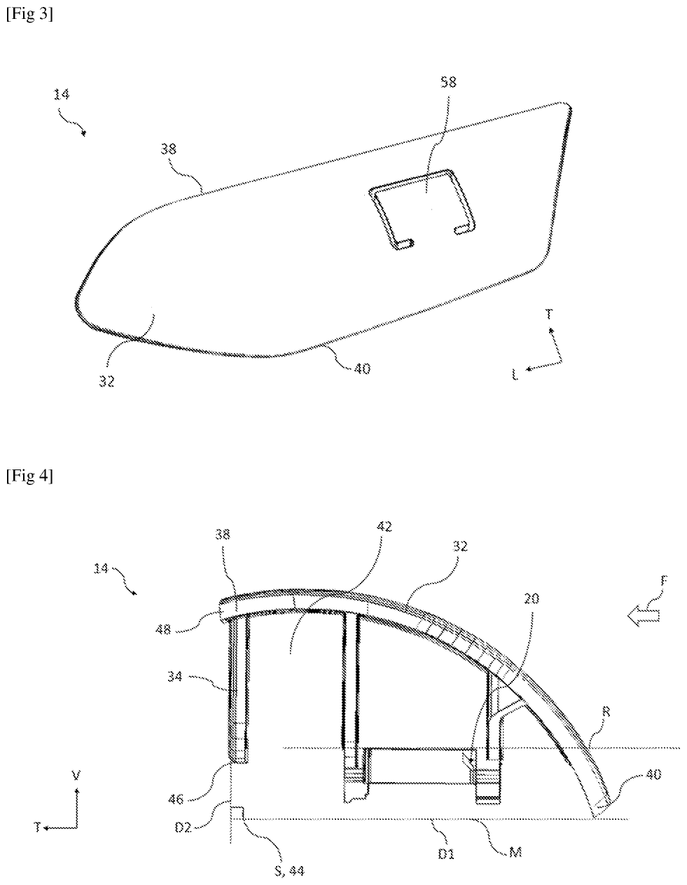

FIG. 3 is a view of the adapter in FIG. 1 showing a curved upper wall;

FIG. 4 is a front view of the adapter in FIG. 1 showing a lateral wall that extends from the upper wall according to a first example of the invention;

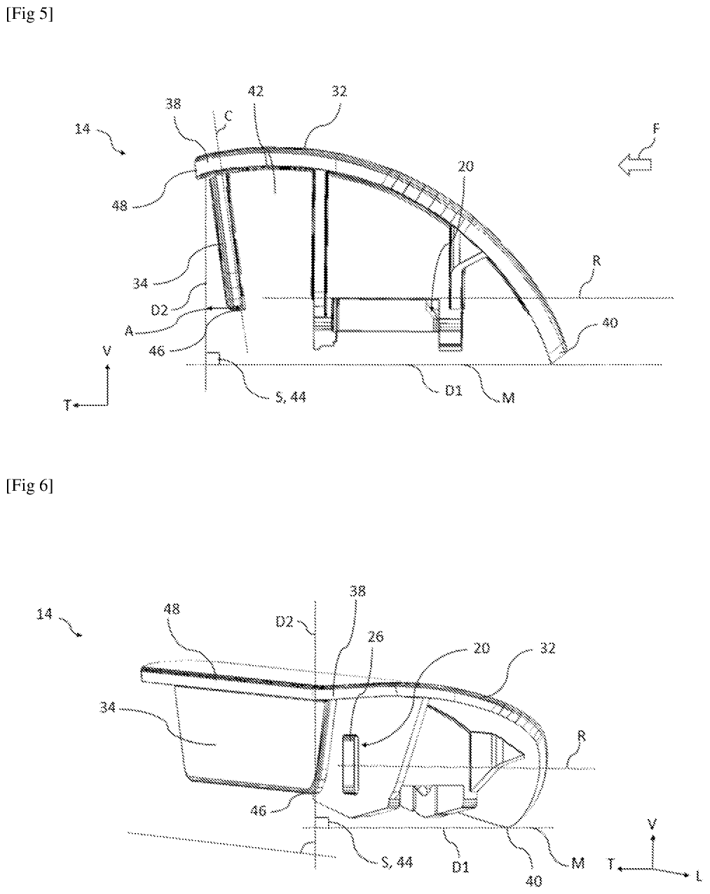

FIG. 5 is a front view of the adapter in FIG. 1 showing a lateral wall that extends from the upper wall according to a second example of the invention;

FIG. 6 is a side view of the adapter in FIG. 1 showing the lateral wall and a deflector that extends from the upper wall.

Firstly, it should be noted that although the figures disclose the invention in detail for the implementation thereof, they can of course be used to further define the invention if applicable. It should also be noted that these figures merely show exemplary embodiments of the invention. Lastly, the same reference signs denote the same elements throughout the figures.

FIG. 1 shows a wiping system 1 for cleaning a glazed surface of a vehicle, for example a windshield, so as to improve the visibility for a driver of the vehicle, in rainy weather for example, or for the purpose of clearing said glazed surface of solid debris clinging thereto. The wiping system 1 extends in a main direction P, in this case a longitudinal direction L, and comprises at least one wiper arm 2 comprising at least one free end 4 holding a wiper 6, and a connection end 8, at the opposite end to the free end 4 in the longitudinal direction L and connected to the vehicle.

The arm 2 and the wiper 6 both extend mainly in the main direction P of the wiping system 1, in this case the longitudinal direction L. The wiper 6 is in particular suitable for being rotated by the arm 2 against the glazed surface of the vehicle, the arm 2 itself being rotated by a motor, not shown, for example an electric motor on board the vehicle.

In order to connect the wiper 6 to the free end 4 of the arm 2, said wiper 6 comprises at least one connector 10 that holds a blade 12 of the wiper 6, and an adapter 14 pivotably mounted on the connector 10, the adapter 14 being able to cooperate with the free end 4 of the arm 2. It will be understood in particular that the blade 12 of the wiper 6 is intended to be in contact with the glazed surface of the vehicle. In addition, the connector 10 is configured to hold the blade 12, directly or indirectly. As can be seen in FIG. 1, the wiper 6 can also comprise at least one pressing member 16 comprising a bearing surface 18 configured so that, when the wiping system 1 is installed on the vehicle, the bearing surface 18 extends across a path of the air flow F when the vehicle is in motion. The at least one pressing member 16 is thus intended to improve the pressing of the wiper 6 against the glazed surface, due to the force of the air flow F exerted on the bearing surface 18. According to the example of the invention shown, the wiper 6 has two pressing members 16, positioned on either side of the connector 10.

The adapter 14 that can be seen in particular in FIGS. 2 to 6 extends in the longitudinal direction L and is rotatably mounted on the connector of the wiper about an axis of rotation R transverse to the longitudinal direction L, by means of a rotation device 20. The rotation device 20, which can be seen in FIG. 2, comprises at least one space 22 for receiving a complementary pivoting member, not shown, formed on the connector, a rotation bearing 24 and a receiving aperture 26. More specifically, the rotation bearing 24 is formed on an elastically deformable tab 28, protruding from the receiving aperture 26 and suitable for cooperating with an opening of the complementary pivoting member, the receiving aperture 26 being open at least facing the receiving space 22 so as to cooperate with a stud of the complementary pivoting member.

It will then be understood that the axis of rotation R of the adapter 14 on the connector passes transversely through the rotation bearing 24 and the receiving aperture 26. Elastically deformable is given to mean that the tab 28 is able to deform and then return to its initial non-deformed position without failure of the material thereof. Such a feature is advantageous in that it facilitates the insertion of the complementary rotation member of the connector into the receiving space 22 during the mounting of the wiping system 1. In addition and to the same end, the rotation bearing 24 and the receiving aperture 26 each comprise a bevel 30, formed at the opposite end to an upper wall 32 of the adapter 14 that vertically closes one side of the receiving space 22. In other words, the bevels 30 of each of the rotation bearing 24 and the receiving aperture 26 are formed on the latter in the direction of insertion of the adapter 14 into the connector so as to facilitate said insertion.

As can particularly be seen in FIGS. 3 to 6, the adapter 14 comprises at least one lateral wall 34 and the curved upper wall 32. Curved is in particular given to mean that the upper wall 32 has a concave shape when viewed from the rotation device 20. The upper wall 32 comprises at least a first end edge 38 and a second end edge 40 that extend substantially in the longitudinal direction L. As can be seen in FIG. 4, the lateral wall 34 extends from the first end edge 38 of the upper wall 32. It will thus be understood that the upper wall 32 and the lateral wall 34 contribute to the definition of an inner volume 42 of the adapter 14 in which the rotation device 20 extends.

According to one feature of the invention, the upper wall 32 has a substantially constant thickness.

According to one feature of the invention, the lateral wall 34 has a substantially constant thickness.

According to the invention, a vertical V and transverse T section S is defined, referred to hereinafter as the adapter section 44, delimited by a first straight line D1 parallel to the axis of rotation R and passing through at least one point of the second end edge 40, by a second straight line D2 perpendicular to the first straight line D1 and passing through at least one point of the first end edge 38, and by the curved upper wall 32 taken in the vertical V and transverse T section. The adapter section 44 is thus contained in the inner volume 42 of the adapter 14 defined above. In other words, it will be understood that the point of the second end edge 40 corresponds to the point on the second end edge 40 of the upper wall 32 that is furthest from the axis of rotation R, in the vertical direction V. Likewise, it will be understood that the point of the first end edge 38 of the upper wall 32 corresponds to the point on the first end edge 38 of the upper wall 32 that is furthest from the axis of rotation R, in the transverse direction T.

According to one feature of the invention, at least one point of the second end edge 40 of the upper wall 32 extends beyond the point of the rotation device 20 in the vertical direction V.

According to a feature of the invention that can particularly be seen in FIG. 4, the lateral wall 34 thus extends from the upper wall 32 so that at least one point of a free end 46 of the lateral wall 34 is contained in the adapter section 44. In other words, at least one point of the free end 46 of the lateral wall 34 is contained inside a perimeter M of the adapter section 44. It will further be understood that the free end 46 of the lateral wall 34 corresponds to the opposite end of the lateral wall 34 to the upper wall 32 in the vertical direction V.

It will be understood from such a feature of the invention that the point of the free end 46 of the lateral wall 34 does not extend beyond the point of the second end edge 40 in the vertical direction V. Likewise, the point of the free end 46 of the lateral wall 34 does not extend beyond the point of the first end edge 38 in the transverse direction T.

According to one feature of the invention, the lateral wall 34 extends from the upper wall 32 so that at least one point of a free end 46 of the lateral wall 34 does not extend beyond the axis of rotation R in the vertical direction V.

According to the example of the invention in FIG. 4, the point of the free end 46 of the lateral wall 34 is positioned in a longitudinal L and vertical V plane passing through the first end edge 38. In other words, the point of the free end 46 of the lateral wall 34 is positioned on the edge of the perimeter M of the adapter section 44.

According to another example of the invention that can be seen in FIG. 5, the point of the free end 46 of the lateral wall 34 is positioned in the adapter section 44 and a non-zero distance A from the longitudinal L and vertical V plane passing through the first end edge 38, the distance A being taken along a straight line parallel to the axis of rotation R. In other words, the lateral wall 34 extends in a main plane C intersecting the longitudinal L and vertical V plane passing through the first end edge 38 and so that the point of the free end 46 of the lateral wall 34 is positioned in the adapter section 44.

According to one feature of the invention that can be seen in FIGS. 4 to 6, the curved upper wall 32 comprises at least one air deflector 48 that extends from the first end edge 38 beyond the lateral wall 34 in the transverse direction T of the adapter 14. It will therefore be understood that the deflector 48 extends from the first end edge 38 of the curved upper wall 32, in the opposite direction to the inner volume 42 of the adapter 14. In addition, and as can particularly be seen in FIG. 6, the deflector 48 extends in the longitudinal direction L from the whole first end edge 38 of the curved upper wall 32.

According to a first embodiment of the invention, the air deflector 48 extends in the continuation of the curvature of the upper wall 32. In other words, the air deflector 48 extends from the first end edge 38 so that it has a concave shape when viewed from the rotation device 20. According to a second embodiment of the invention, not shown, the air deflector protrudes from the first end edge of the upper wall, extending in the opposite direction to the lateral wall in the vertical direction. In other words, the deflector has a curved profile in a vertical and transverse plane, the curvature being convex when viewed from the rotation device of the adapter.

The air deflector 48 of the adapter 14 is advantageous in that it contributes to pressing the wiper against the glazed surface and also to increasing the negative pressure effect at the rear of the adapter, that is, transversely in the opposite direction to a contact zone of the air flow with the adapter when it is mounted on the vehicle.

As can particularly be seen in FIG. 2, the adapter 14 comprises at least one receiving recess 50 configured to receive the arm of the wiping system. More particularly, the inner volume 42 of the adapter 14 comprises the receiving recess 50 configured to receive the arm of the wiping system.

More specifically, the receiving recess 50 is delimited by at least four supporting walls 52 positioned perpendicular to each other so as to form an at least partially parallelepipedal receiving recess 50. Each of the supporting walls 52 then extends in a plane intersecting a longitudinal L and vertical V plane of the adapter 14 so as to form a receiving recess 50 inclined relative to said longitudinal L and vertical V plane.

In addition, the receiving recess 50 comprises at least one locking member 56 configured to longitudinally block the arm in the receiving recess 50. More particularly, the locking member 56 contributes to the definition of the receiving recess 50 and comprises at least one handling means 58, which can be seen in FIG. 3, inscribed in the curvature of the upper wall 32. More specifically, the locking member 56 comprises a blocking member 60 that contributes to the definition of the receiving recess 50, said blocking member 60 being connected to the handling means 58 via a connecting member 62. The handling means 58 then form an elastically deformable portion that, when it is deformed, makes it possible to move the blocking member 60 in the vertical direction V, the blocking member then releasing the arm from the longitudinal blocking. It will be understood in particular that when the handling means 58 are not deformed, the blocking member 60 longitudinally blocks the arm in position.

In addition, in this non-limiting example of the invention, the handling means 58 are deformed by a vertical pressing force exerted on said handling means 58 so as to move said handling means 58 in the inner volume 42 of the adapter 14.

It will be understood from the above that when the wiping system is mounted, the arm is inserted into the receiving recess 50 by longitudinal translation until it comes into contact with the blocking member 60. The arm can then be removed by deformation of the handling means 58, moving the blocking member 60 vertically and thus releasing the arm from the longitudinal blocking previously provided by the blocking member 60.

The invention as described above is advantageous in that it makes it possible to both increase the overall pressing of the wiper against the glazed surface, and increase the negative pressure effect at the rear of the adapter. In other words, the specific structure of the adapter and in particular of its lateral wall, the point of the free end of which is contained in the adapter section, makes it possible to increase the negative pressure effect at the rear of the adapter, thus contributing to pressing the wiper against the glazed surface when the vehicle is in motion.

The invention as described above is not, however, limited to the means and configurations exclusively described and illustrated, and also applies to all equivalent means or configurations and to any combination of such means or configurations.

1. An adapter (14) for fastening a wiper (6) to an arm (2) of a wiping system (1), the adapter (14) extending in a longitudinal direction (L), the adapter (14) being configured to be rotatably mounted on a connector (10) of the wiper (6) about an axis of rotation (R) transverse to the longitudinal direction (L) by means of a rotation device (20), the adapter (14) comprising at least one lateral wall (34) and a curved upper wall (32) comprising at least a first end edge (38) and a second end edge (40) that extend substantially in the longitudinal direction (L), the adapter (14) being defined by a vertical (V) and transverse (T) section (S), the section (S) being delimited by a first straight line (D1) parallel to the axis of rotation (R) and passing through at least one point of the second end edge (40), by a second straight line (D2) perpendicular to the first straight line (D1) and passing through at least one point of the first end edge (38), and by the curved upper wall (32) taken in the vertical (V) and transverse (T) section (S), the adapter (14) being characterized in that the lateral wall (34) extends from the upper wall (32) and so that at least one point of a free end (46) of the lateral wall (34) is contained in the vertical (V) and transverse (T) section (S).

2. The adapter (14) as claimed in the preceding claim, wherein the lateral wall (34) extends from the first end edge (38) of the upper wall (32) so as to extend in a longitudinal (L) and vertical (V) plane.

3. The adapter (14) as claimed in any one of the preceding claims, wherein the point of the free end (46) of the lateral wall (34) is positioned in a longitudinal (L) and vertical (V) plane passing through the first end edge (38).

4. The adapter as claimed in claim 1, wherein the point of the free end (46) of the lateral wall (34) is positioned in the vertical (V) and transverse (T) section (S) and a non-zero distance (A) from a longitudinal (L) and vertical (V) plane passing through the first end edge (38).

5. The adapter (14) as claimed in any one of the preceding claims, wherein the curved upper wall (32) comprises at least one air deflector (48) that extends from the first end edge (38) beyond the lateral wall (34) in the transverse direction (T) of the adapter (14).

6. The adapter (14) as claimed in the preceding claim, wherein the air deflector (48) extends in the continuation of the curvature of the curved upper wall (32).

7. The adapter (14) as claimed in claim 5, wherein the air deflector (48) protrudes from the first end edge (38) of the upper wall (32), extending in the opposite direction to the lateral wall (34) in the vertical (V) direction.

8. The adapter (14) as claimed in any one of the preceding claims, wherein the upper wall (32) has a concave shape when viewed from the rotation device (20).

9. The adapter (14) as claimed in any one of the preceding claims, comprising at least one receiving recess (50) configured to receive the arm (2) of the wiping system (1), the receiving recess (50) being delimited by at least four supporting walls (52) perpendicular to each other, each of the supporting walls (52) extending in a plane intersecting a longitudinal (L) and vertical (V) plane of the adapter (14).

10. The adapter (14) as claimed in any one of the preceding claims, wherein the receiving recess (50) configured to receive the arm (2) of the wiping system (1) is positioned in an inner volume (42) of the adapter defined by the upper wall (32) and the lateral wall (34) of the adapter (14).

11. A wiper (6) comprising at least one wiper blade (12), a connector (10) and an adapter (14) as claimed in any one of the preceding claims, the blade (12) being held directly or indirectly by the connector (10), and the adapter (14) being pivotably mounted relative to the connector (10).

12. A wiping system (1) for a motor vehicle, which comprises a wiper (6) as claimed in the preceding claim, connected to an arm (2) of the wiping system (1) by translation of the arm (2) inside the adapter (14).
